(19) United States
(12) Patent Application Publication
(10) Pub. No.: US 2002/0052767 A1
(43) Pub. Date: May 2, 2002

(54) Method and system for managing members

(75) Inventor: Keisuke Yano, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/877,347

(22) Filed: Jun. 8, 2001

(30) Foreign Application Priority Data
Jun. 12, 2000 (JP) 2000-175504

(51) Int. Cl. G06F 17/60

(52) U.S. Cl. 705/7

(57) ABSTRACT

A member management method for managing the registration of members to an Internet Service Provider that provides a connection service to the Internet and for managing information of registered members: performs a prescribed member registration process in units of marketers based on the personal information of a user and identification information of the marketer of the terminal device that are sent from the terminal device of a user who wishes to register as a member; saves, for each member, member information that includes the user's personal information in units of marketers; and provides services that are characteristic for each marketer to the terminal device that is used by the user. A user that has registered as a member is given an Internet terminal device that includes a domain name that is specific to the marketer of the terminal device.

### BACKGROUND OF THE INVENTION

1. Field of the Invention

The present invention relates to a member management method and a member management system for managing the registration of members and managing information of members that are registered to an Internet Service Provider that offers a connection service to the Internet.

2. Description of the Related Art

A user who wishes to use the Internet requests registration as a member online to any Internet Service Provider (hereinbelow abbreviated “ISP”) that provides a connection service to the Internet using, for example, sign-up software belonging to a purchased terminal device or sign-up software that can be obtained from, for example, a marketer of terminal devices or a magazine.

To increase the number of members, it is preferable to the ISP that marketers of terminal devices recommend the ISP to users wishing to use the Internet. However, a marketer is unlikely to perform this service for a particular ISP unless it obtains some advantage.

Users of the Internet, on the other hand, look for an ISP that both enables reliable use of the Internet and provides a full range of other services.

### SUMMARY OF THE INVENTION

The present invention was realized to solve problems of the above-described prior art and has as an objective the provision of a member management method and member management system that can not only increase the number of members for the ISP but can also benefit marketers of terminal devices and users who wish to use the Internet.

The member management method of the present invention that can achieve the above-described objects not only manages the process of registering members to an Internet Service Provider that provides a connection service to the Internet but manages the information of registered members; and is a method that:

based on personal information of a user who wishes to register as a member and identification information of a marketer of the terminal device that is used by the user that are transmitted from the terminal device, performs a prescribed member registration process in units of marketers;

saves member information that includes the user's personal information in units of corresponding marketers;

provides a service that is characteristic to each marketer to the terminal device that is used by the user, and gives to the user that has registered as a member an Internet address that includes a domain name that is specific to the marketer of the terminal device that is used by the user; and

saves member information that includes the user's personal information in units of each marketer according to the domain name that is included in the Internet address.

The member management system of the present invention for both managing the process of registering members to an Internet Service Provider that provides a connection service to the Internet and managing information of registered members is a configuration that includes:

a marketer server device for saving member information that includes personal information of its members and providing services characteristic of the marketer to the terminal devices that are used by the members; and

a member management server device that, based on personal information of the users and identification information of the marketers of the terminal devices that are transmitted from terminal devices that are used by users who wish to register as members, performs a prescribed member registration process in units of marketers and transmits the users' personal information to the corresponding marketer server device;

wherein the member management server device:

is a configuration that gives to users who have performed the member registration process an Internet address that contains a domain name that is specific to the marketer of the terminal device that is used by the user;

and the marketer server device:

is a configuration that saves member information that includes users' personal information in units of marketers according to the domain name that is included in the Internet address.

At this time, the marketer server device:

upon transmission of a user's personal information from the terminal device that is used by a user who wishes to register as a member, may both save the personal information and transmit the personal information to the member management server device;

and the member management server device:

may perform a prescribed member registration process based on the personal information and the identification information of the corresponding marketer that have been transmitted from the marketer server device.

In addition, another configuration of the member management system of the present invention for both managing the process of registering members to an Internet Service Provider that provides a connection service to the Internet and managing information of registered members includes:

a member management server device that, based on a user's personal information and identification information of the marketer of the terminal device that are transmitted from a terminal device that is used by a user that wishes to register as a member, performs a member registration process in units of marketers, saves member information that includes the user's personal information in units of the corresponding marketers, and provides to the terminal device that is used by the user services that are characteristic of each marketer;

wherein the member management server device: gives a user that has registered as a member an Internet address that includes a domain name that is specific to the marketer of the terminal device that is used by the user; and

saves member information that includes the user's personal information in units of marketers according to the domain name that is included in the Internet address.

In the above-described member management method and system, a prescribed member registration process is performed in marketer units based on users' personal information and identification information of the marketers of terminal devices, member information that includes the users' personal information is saved for each member in units of the corresponding marketers, and services that are characteristic of each marketer are provided to terminal devices that are used by users; whereby:

a marketer of a terminal device can provide the optimum product information to each member using the member's personal information.

The above and other objects, features, and advantages of the present invention will become apparent from the following description based on the accompanying drawings which illustrate examples of preferred embodiments of the present invention.

### BRIEF DESCRIPTION OF THE DRAWINGS

FIG. 1 is a block diagram showing an example of the configuration of a member management system of the present invention.

FIG. 2 is a block diagram showing an example of the configuration of the member management server device that is shown in FIG. 1.

FIG. 3 is a sequence chart showing the procedures of the member management method of the present invention.

FIG. 4 is a table showing an example of the management of a member's history information.

### DETAILED DESCRIPTION OF THE PREFERRED EMBODIMENTS

The present invention is next described with reference to the accompanying figures. The member management method and member management system of the present invention set the marketer (marketing company) of a terminal device to a virtual ISP (hereinbelow referred to as “VSP”) that provides a connection service to the Internet, and an actual ISP (hereinbelow referred to as “actual ISP”) provides the user with a connection service to the Internet in place of the VSP. The actual ISP manages the member registration process to the VSP, history information such as the amount of access time to the Internet and connection charges, and member information that includes personal information of the member.

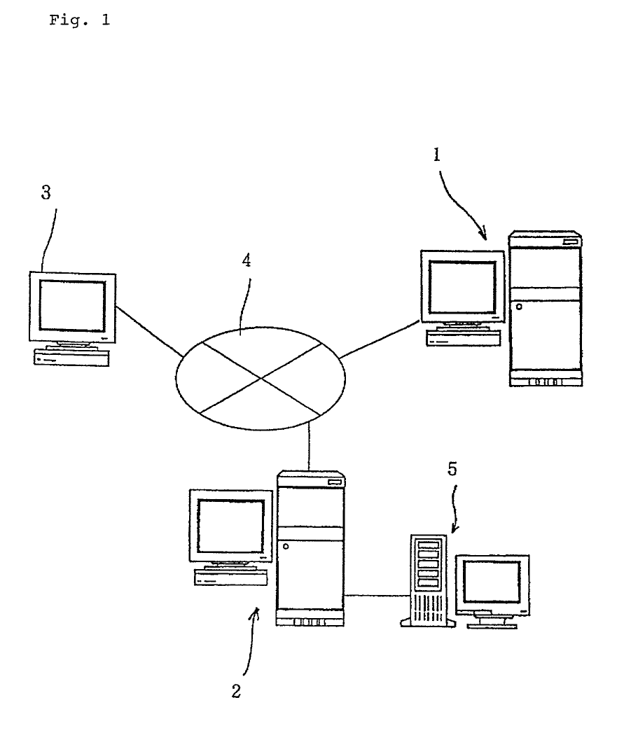

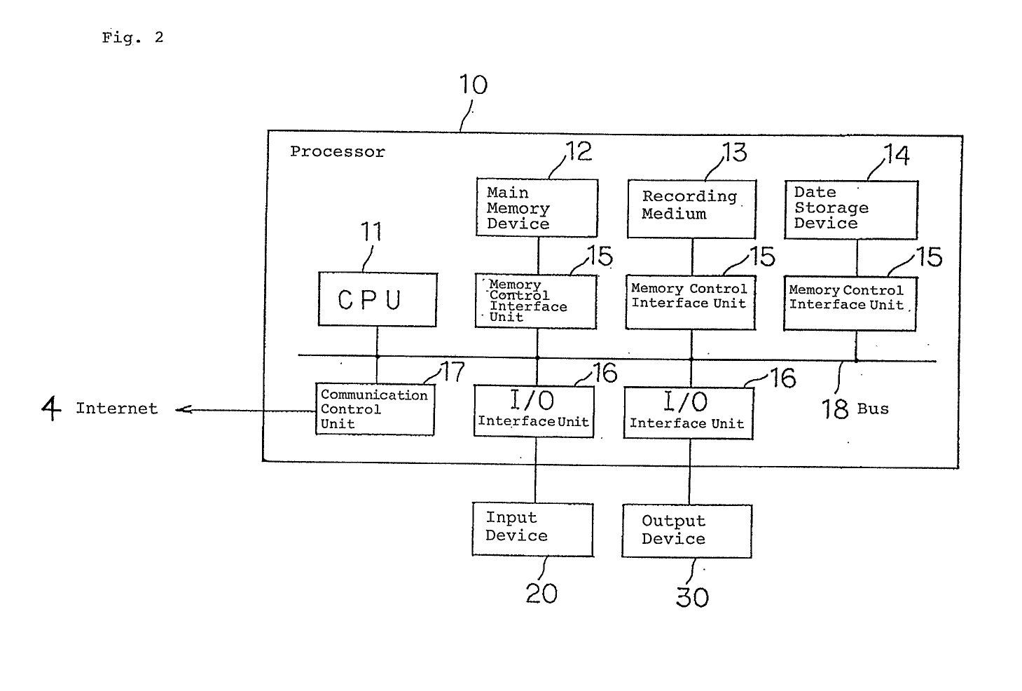

FIG. 1 is a block diagram showing an example of the configuration of the member management system of the present invention, and FIG. 2 is a block diagram showing an example of the configuration of the member management server device that is shown in FIG. 1.

As shown in FIG. 1, the member management system of the present invention includes: member management server device 1 that carries out the process of member registration to a VSP for users who wish to use the Internet and that manages history information and member information that includes personal information of members; and marketer server device 2 that manages the member information of its own VSP. Member management server device 1, marketer server device 2, and user terminal device 3, which is the terminal device used by the user, have an architecture that is connected so as to allow data communication between these components via Internet 4. In addition, marketer terminal device 5, which is a terminal device that is used by the marketer, is connected to marketer server device 2. Marketer terminal device 5 is connected to Internet 4 via marketer server device 2, and can exchange data with member management server device 1.

Member management server device 1 is managed by, for example, an actual ISP; and marketer server device 2 is managed by the marketer of the terminal device, which is a VSF, or by a third party (for example, an actual ISP) to whom the marketer has entrusted operation. Member management server device 1 and marketer server device 2 are information processing devices such as workstation servers, and user terminal device 3 is an information processing device such as a personal computer or portable telephone that is provided with functions that allow connection to Internet 4. In addition, marketer terminal device 5 is an information processing device such as a personal computer that has functions to allow connection to marketer server device 2. Although FIG. 1 shows a configuration that is provided with one user terminal device 3 and one marketer terminal device 5, in actuality, a large number of user terminal devices 3 are connected to Internet 4, and a large number of marketer terminal devices 5 are connected to marketer server device 2. Furthermore, information on the amount of Internet access time for each member is transferred to member management server device 1 from an Internet connection device not shown in the figures that provides users with a connection service to the Internet.

As shown in FIG. 2, member management server device 1 has a construction that includes: processor 10 that executes prescribed processing in accordance with a program, input device 20 for entering commands and information that are directed to processor 10, and output device 30 for monitoring the processing results of processor 10.

Processor 10 is provided with: CPU 11; main memory device 12 for temporarily storing information that is necessary for the processing of CPU 11; recording medium 13 on which is recorded a management program for causing CPU 11 to manage the member registration process, history information, and member information; data storage device 14 for recording member information that includes personal information of members; memory control interface unit 15 for controlling data transfer of main memory device 12, recording medium 13, and data storage device 14; I/O interface unit 16, which is the interface of input device 20 and output device 30; and communication control unit 17, which is an interface for controlling data communication with a destination via Internet 4. Processor 10 has a construction in which these components are interconnected by bus 18.

Processor 10 of member management server device 1 executes the processing of member management server device 1 described hereinbelow in accordance with a management program that is recorded on recording medium 13. In addition, recording medium 13 may be a magnetic disc, a semiconductor memory, an optical memory disc, or another recording medium.

With the exception of differences in information that is recorded on data storage device 14 and recording medium 13, marketer server device 2, user terminal device 3, and marketer terminal device 5 are basically of the same construction as member management server device 1, and explanation of these components is therefore omitted.

Data storage device 14 of member management server device 1 saves, in units of each VSP, Member information that includes: personal information of each member such as the member's name, gender, date of birth, contact information, credit card number, and Internet address; history information such as the amount of access time and the state of payment of Internet connection charges; and survey results on, for example, interests, hobbies, customer treatment at the time of purchasing the terminal device, and information on products that the user wishes to have delivered. Member management server device 1 adds to the Internet address that is given to each user a specific domain name for each VSP to which that user belongs. In this way, member management server device 1 can easily identify the VSP to which each member belongs by means of the domain name. The actual ISP may then pay a percentage to marketers according to, for example, the number of members of the VSP or the Internet connection charges that have been paid by each member of a VSP.

Marketer server device 2 keeps the member information, which includes personal information or the results of surveys of the members of its own VSP, and using electronic mail, delivers to user terminal devices 3 that are used by members of its own VSP information optimized for each member such as, for example, information that corresponds to a member's interests or hobbies or information on desired products. Alternatively, the marketer may provide services to members of its own VSP such as awarding points upon purchase of products, delivering birthday cards, or any other benefits that are individually set.

In addition, a Web page that advertises the marketer's store or VSP may also be registered on marketer server device 2, and accessing this Web page by means of user terminal device 3 may enable member registration to the VSP. Personal information or survey results of a member that are sent to marketer server device 2 are both saved in marketer server device 2 and transmitted to member management server device 1. Member management server device 1 both performs a prescribed member registration process in VSP units based on the personal information that is transmitted from marketer server device 2 and records member information that includes the personal information in data storage device 14.

Member management server device 1 and marketer server device 2 can be accessed not only from user terminal device 3 but also from marketer terminal device 5, and member registration is therefore possible in the marketer's store premises by using marketer terminal device 5.

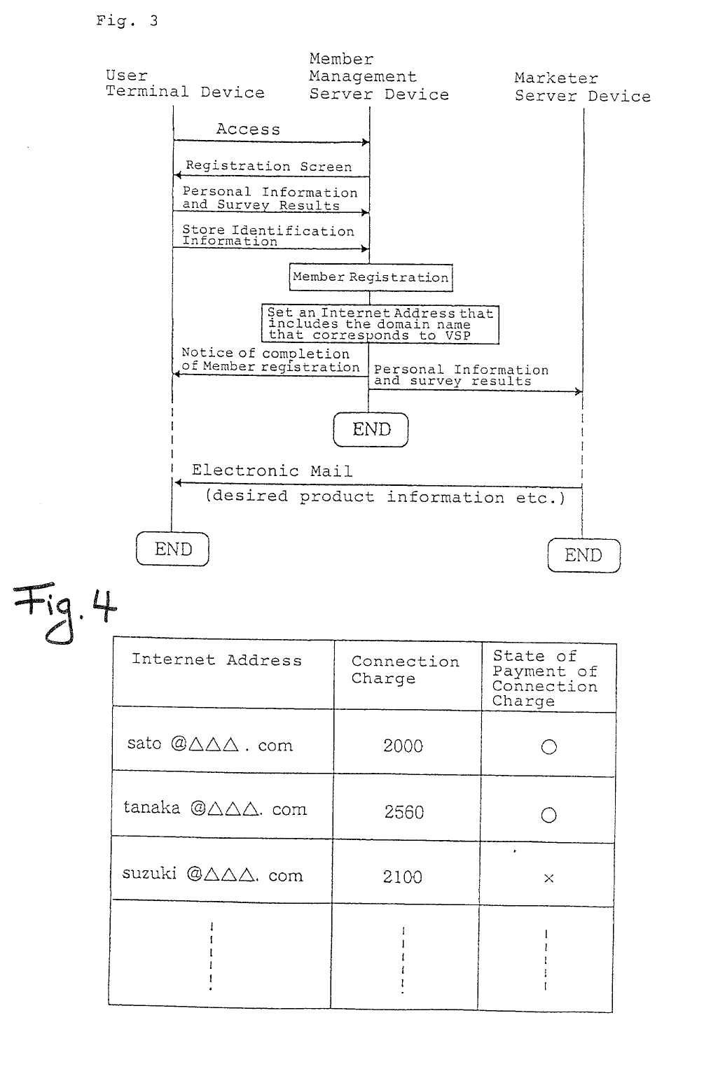

The procedures of the member management method of the present invention in this type of configuration are next explained using FIGS. 3 and 4.

FIG. 3 is a sequence chart showing the procedures of the member management method of the present invention, and FIG. 4 is a table showing an example of the management of member history information.

In FIG. 3, when a user that wishes to use the Internet uses user terminal device 3 to access member management server device 1 via Internet 4, member management server device 1 sends back image data of a registration screen for performing member registration.

The user enters the personal information that is required for member registration and survey results to user terminal device 3 in accordance with the registration screen, and when the user clicks on the “Send” button (for example, a banner) on the screen, user terminal device 3 transmits the personal information and survey results that have been entered to member management server device 1.

As described hereinabove, the personal information that has been transmitted from user terminal device 3 includes the user's name, gender, date of birth, contact information, credit card number, a desired Internet address (an address for identifying a member other than the shared portions such as the domain name), and the survey results include interests, hobbies, the marketer's customer treatment when the terminal device was purchased, or product information that the user wishes to receive. In addition, the information that is transmitted from user terminal device 3 to member management server device 1 at this time also includes identification information for identifying the store at which the terminal device was purchased. The identification information may, for example, be included in advance in the sign-up software that is supplied from the marketer for accessing member management server device 1, or the marketer's name may be sent back from the user as part of the survey results.

Member management server device 1 that has received personal information, survey results, and identification information from user terminal device 3 judges whether or not member registration is possible by a known method (for example, confirmation of the credit card number or expiration date). If member registration is possible, member management server device sets an Internet address that includes the domain name that corresponds to the VSP and registers the user as a member of the corresponding VSP. Member management server device 1 then sends back notice of completion of member registration to user terminal device 3 and sends the member's personal information that includes an Internet address and survey results to marketer server device 2 of the corresponding VSP.

Marketer server device 2, having received the personal information and survey results of the VSP members, uses this information to provide the marketer's own services to each member. For example, marketer server device 2 may deliver information relating to a member's interests or hobbies or desired product information as electronic mail to user terminal device 3 that is used by its VSP member.

When users who have completed member registration use user terminal devices 3 to access Internet 4, the actual ISP is paid from each member for connection charges to the Internet by a known method according to the amount of access time (or a fixed amount).

As shown in FIG. 4, member management server device 1 holds as a table in data storage device 14 history information such as the access time, connection charges, and the state of payment of connection charges for each user. The actual ISP refers to history information that is stored in data storage device 14 of member management server device 1, and may pay a percentage to the marketer according to the number of members of the VSP or according to the amount of Internet connection charges that have been paid by each member.

Accordingly, a marketer of a terminal device can receive, for example, a percentage from an actual ISP by securing VSP members. Furthermore, the effect of presenting products or other items or services to members can be improved because optimum information for each member can be provided based on the personal information of VSP members.

On the other hand, the actual ISP can effectively increase the members of its own ISP when each marketer secures more VSP members.

Furthermore, a user that has registered with the VSP as a member is able to receive original services from the marketer that is the VSP in addition to services that are provided from the actual ISP.

Although an example has been presented in FIG. 3 in which a member was registered by accessing member management server device 1 from user terminal device 3, a member may also be registered by accessing the VSP Web page that is registered in marketer server device 2 from user terminal device 3 and then following the display of the Web page, as described hereinabove. In such a case, the personal information and survey results that are transmitted from user terminal device 3 to marketer server device 2 are both saved by marketer server device 2 and transmitted to member management server device 1, where they are stored in data storage device 14 of member management server device 1. Member management server device 1 both performs a prescribed member registration process in VSP units based on the personal information, survey results, and identification information of the marketer that are transmitted from marketer server device 2, gives an Internet address that includes a domain name that is specific to each VSP, and sends back this Internet address to corresponding marketer server device 2 and user terminal device 3. The member registration process can be realized by the same procedure by accessing marketer server device 2 or member management server device 1 from user terminal device 3 or from marketer terminal device 5.

Although a configuration was described in the above-described explanation in which the member management system included marketer server device 2 and marketer terminal device 5, the configuration may include only marketer terminal device 5. In such a case, the processing of the above-described marketer server device 2 is executed by member management server device 1 that is managed by the actual ISP.

The present invention having the above-described constitution provides the following effects:

As a result of carrying out a prescribed member registration process in marketer units based on a user's personal information and identification information of the marketer of the terminal device, saving member information that includes a user's personal information in units of corresponding marketers, and providing special services by each marketer to the terminal device that is used by a user, the marketer of a terminal device can use a member's personal information to provide, for example, optimum product information for each member and thereby improve, for example, the effect of presenting products to members.

In addition, users who have registered as members can receive through the terminal device services from the marketer in addition to services that are provided by the Internet service provider. Furthermore, an Internet service provider can effectively increase the number of members if each marketer of terminal devices obtains more members.

While a preferred embodiment of the present invention has been described using specific terms, such description is for illustrative purposes only, and it is to be understood that changes and variations may be made without departing from the spirit or scope of the following claims.

What is claimed is:

1. A member management method for managing a process of registering members to an Internet Service Provider that provides a connection service to the Internet and further, for managing information of registered members, comprising the steps of:
performing a prescribed member registration process in units of marketers, based on personal information of a user who wishes to register as a member and identification information of a marketer of a terminal device that is used by the user that are transmitted from the terminal device;
saving said member information that includes said user's personal information in units of corresponding marketers; and
providing a service that is characteristic of each marketer to the terminal device that is used by said user.

2. A member management method according to claim 1, further comprising the steps of:
giving to the user that has registered as a member an Internet address that includes a domain name that is specific to the marketer of the terminal device that is used by the user; and
saving said member information that includes personal information of the user in units of each marketer according to the domain name that is included in said Internet address.

3. A member management system for managing a process of registering members to an Internet Service Provider that provides a connection service to the Internet and for managing information of registered members, comprising:
a marketer server device for saving said member information that includes personal information of members and providing services that are characteristic of a marketer to terminal devices that are used by the members; and
a member management server device that, based on personal information of users who wish to register as members and identification information of the marketers of the terminal devices that are transmitted from the terminal devices that are used by the users, performs a prescribed member registration process in units of said marketers and transmits the users' personal information to the corresponding marketer server device.

4. A member management system according to claim 3 wherein said member management server device
gives to a user who has performed the member registration process an Internet addresses that contains a domain name that is specific to the marketer of the terminal device that is used by the user,
and said marketer server device
saves said member information that includes the user's personal information in units of marketers according to the domain name that is included in said Internet address.

5. A member management system according to claim 3 wherein:
said marketer server device
upon transmission of a user's personal information from the terminal device that is used by a user who wishes to register as a member, both saves the personal information and transmits the personal information to said member management server device, and
said member management server device
performs a prescribed member registration process based on the personal information and identification information of the corresponding marketer that have been transmitted from said marketer server device.

6. A member management system according to claim 4 wherein:
said marketer server device
upon transmission of a user's personal information from the terminal device that is used by a user who wishes to register as a member, both saves the personal information and transmits the personal information to said member management server device, and
said member management server device:
performs a prescribed member registration process based on the personal information and identification information of the corresponding marketer that have been transmitted from said marketer server device.

7. A member management system for managing a process of registering members to an Internet Service Provider that provides a connection service to the Internet and for managing information of registered members, comprising:
a member management server device that, based on a user's personal information and identification information of the marketer of the terminal device that is used by a user that wishes to register as a member that are transmitted from the terminal device, performs a prescribed member registration process in units of marketers, saves member information that includes the user's personal information in units of the corresponding marketers, and provides to the terminal device that is used by the user services that are characteristic of each marketer.

8. A member management system according to claim 7 wherein said member management server device
gives the user that has registered as a member an Internet address that includes a domain name that is specific to the marketer of the terminal device that is used by the user, and
saves said member information that includes the user's personal information in units of marketers according to the domain name that is included in said Internet address.

9. A server device for managing a process of registering members to an Internet Service Provider that provides a connection service to the Internet and managing information of registered members, comprising:
a processor for receiving, from a user that wishes to register as a member via a terminal device that is used by the user, personal information of the user and identification information of a marketer of the terminal device, and executing a prescribed member registration process in units of said marketers based on the personal information and the identification information; and
a data storage device for saving said member information that includes said user's personal information.

10. A server device according to claim 9 wherein:
said processor gives to a user that has registered as a member an Internet address that includes a domain name that is specific to the marketer of the terminal device that is used by the user; and
said data storage device saves said member information that includes the users' personal information in units of said marketers according to the domain name that is included in said Internet address.

11. A server device for managing information of members that are registered to an Internet Service Provider that provides a connection service to the Internet, comprising:
a data storage device for saving said member information that includes personal information of users who have registered as members; and
a processor that uses the personal information to provide services that are characteristic of each marketer to terminal devices that are used by the users.

12. A server device according to claim 11 wherein said processor receives personal information from users who wish to register as members, saves the personal information in said data storage device, and transmits the personal information to a member management server device that executes a prescribed member registration process based on the personal information.
